(19) United States
(12) Patent Application Publication
(10) Pub. No.: US 2026/0062303 A1
(43) Pub. Date: Mar. 5, 2026

(54) FABRICATION METHODS TO ENHANCE THE PRODUCTION YIELD AND MATERIAL QUALITY OF MXENES

(71) Applicant: Lawrence Livermore National Security, LLC, Livermore, CA (US)

(72) Inventors: Jinkyu Han, Danville, CA (US); John Berns Lancaster, Livermore, CA (US)

(21) Appl. No.: 18/818,420

(22) Filed: Aug. 28, 2024

(51) Int. Cl. C01B 32/921; C09K 13/00

(52) U.S. Cl. CPC C01B 32/921; C09K 13/00

(57) ABSTRACT

In one general approach, a method for fabricating a MXene includes etching a MAX phase for selectively removing an A group element from the MAX phase, thereby forming a multilayer MXene. The multilayer MXene is then intercalated and exfoliated. In another general approach, a method for fabricating a MXene includes contacting a MAX phase with an acid and a fluorophosphate salt in a nonaqueous solvent for selectively removing an A group element from the MAX phase, thereby forming a multilayer MXene. The multilayer MXene is then intercalated and exfoliated.

This invention was made with Government support under Contract No. DE-AC52-07NA27344 awarded by the United States Department of Energy. The Government has certain rights in the invention.

### FIELD OF THE INVENTION

The present invention relates to MXenes, and more particularly, this invention relates to methods for producing MXenes.

### BACKGROUND

Electromagnetic (EM) shielding becomes a critical requirement for communication stability and security in next-generation communication systems (e.g., 5G and beyond) due to a significant increase in the number of miniaturized modern electronic devices. Currently, shielding is provided by conventional metals. However, sheets of metal suffer from many drawbacks, including that they are heavy, bulky, costly to manufacture, not efficient at ultrathin thickness, and are susceptible to corrosion.

The MXene family of two-dimensional (2D) materials is comprised of transition metal carbides, carbonitrides, and nitrides with a general formula of Mₙ₊₁Xₙ, where M represents transition metals (such as Sc, Ti, Zr, Hf, V, Nb, Ta, Cr, Mo, etc.) and X is carbon and/or nitrogen. The name “MXene” was given to describe the similarities between this 2D material family and graphene, but also to recognize the parent ternary carbide and nitrides, MAX phases, which MXenes are synthesized from.

2D transition metal carbides in the MXene family are receiving significant attention as next-generation EM shielding materials by resolving the foregoing issues with conventional metal shielding. MXenes are lightweight; ultrathin; flexible; potentially easier to manufacture in various forms such as films, devices, and coatings; and highly efficient to protect the system from undesirable EM radiation such as EM interference (EMI) and EM pulse (EMP), which can cause the leakage of confidential information and targets, lead to the malfunction of electronic devices, and even impair human health.

However, an unresolved challenge for MXenes that prevents their practical utilization is that they are currently synthesized in small quantities (e.g. <grams) due to low production yield (e.g., 10-20%). Moreover, efforts to scale their synthesis to larger quantities (e.g. kgs) typically results in materials with poorer performance.

For instance, MXenes reported to date are synthesized by wet-chemical etching in highly concentrated hydrofluoric acid (HF) or HF-containing or HF-forming etchants, which add surface functionalities such as —O,—F, or —OH, represented by Tₓ in this formula as Mₙ₊₁XₙTₓ. Etching is required because of strong chemical bonds between A and M elements in MAX phases that make mechanical exfoliation hardly possible.

Ti₃C₂Tₓ “clay” was synthesized by taking advantage of making in situ HF through addition of lithium fluoride (LiF) salt to hydrochloric acid (HCl), significantly simplifying the synthesis method and improving MXene performance in energy storage applications. With the need for methods to increase the delamination yield, additional organic intercalants were used, such as isopropylamine and tetrabutylammonium hydroxide. Of the handful of recently reported efforts to scale up the synthesis of MXenes, however, they are still in the early stages of development and suffer from low yield (e.g. 10-20%) and quantities, and 2) size and morphology inhomogeneity, which results in variability in EM shielding performance.

What is needed is a way to address these challenges, as well as enable a method of production of MXenes that is capable of scale-up.

### SUMMARY

A method for fabricating a MXene, in accordance with one aspect of the present invention, includes etching a MAX phase for selectively removing an A group element from the MAX phase, thereby forming a multilayer MXene. The multilayer MXene is then intercalated and exfoliated.

A method for fabricating a MXene, in accordance with another aspect of the present invention, includes contacting a MAX phase with an acid and a fluorophosphate salt in a nonaqueous solvent for selectively removing an A group element from the MAX phase, thereby forming a multilayer MXene. The multilayer MXene is then intercalated and exfoliated.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a graphical depiction of three exemplary structures of MXenes that may be produced using the methodology presented herein.

FIG. 2 is a flowchart of a method, in accordance with one embodiment.

FIG. 3 is a flowchart of a variant of the method of FIG. 2, in accordance with a preferred embodiment.

FIG. 4 is a graphical representation of a method 400 for performing a scalable solution-phase synthesis of freestanding MXene via top-down exfoliation, in accordance with various approaches.

FIG. 5, part (A), is an image showing the colloidal stability of Ti₃C₂Tₓ MXene in DMSO before and after delamination and purification steps during an experiment.

FIG. 5, part (B), includes images showing a freestanding film produced by vacuum filtration during the experiment.

FIG. 6, part (A), is a chart showing the shielding effectiveness of freestanding films of Ti₃C₂Tₓ MXene, with Cu foil as a comparison.

FIG. 6, part (B), is a chart illustrating normalized shielding effectiveness by density and weight (SSE/t) of Ti₃C₂Tₓ MXene vs. other materials.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred approaches of methods for fabrication of MXenes with higher yield than heretofore possible. One aspect includes a scalable solution-phase synthesis methodology to generate MXenes with over 25%, preferably at least 50%, and more preferably about 75% or more (up to some reasonable percentage that is below the theoretical limit), production yield via top-down exfoliation approaches with non-aqueous solvents and salts, which result in dramatically improved yields compared to conventional approaches (e.g., 10-20% yield by conventional methods). Furthermore, the shielding effectiveness (SE) of the resulting materials are comparable to bulk metals. Moreover, normalized SE by density and thickness is about an order magnitude higher than that of conventional metals (e.g., Cu).

In one general approach, a method for fabricating a MXene includes etching a MAX phase for selectively removing an A group element from the MAX phase, thereby forming a multilayer MXene. The multilayer MXene is then intercalated and exfoliated.

In another general approach, a method for fabricating a MXene includes contacting a MAX phase with an acid and a fluorophosphate salt in a nonaqueous solvent for selectively removing an A group element from the MAX phase, thereby forming a multilayer MXene. The multilayer MXene is then intercalated and exfoliated.

The MXene family of two-dimensional (2D) materials is comprised of transition metal carbides, carbonitrides, and nitrides with a general formula of Mₙ₊₁Xₙ, where M represents transition metals (such as Sc, Ti, Zr, Hf, V, Nb, Ta, Cr, Mo, etc.) and X is carbon and/or nitrogen. The name “MXene” was given to describe the similarities between this 2D material family and graphene, but also to recognize the parent ternary carbide and nitrides, MAX phases, which MXenes are synthesized from.

The methodology presented herein may be used to create MXenes of many different types and compositions.

In some approaches, the M in MXenes created according to the methodology presented herein may be selected from the group consisting of: Sc, Ti, V, Cr, Y, Zr, Nb, Mo, Hf, Ta, W, and Mn.

The M in the MAX phases may also be selected from the group consisting of: Sc, Ti, V, Cr, Y Zr, Nb, Mo, Hf, Ta, W, and Mn. In some approaches, the MXenes have one or more surface terminations selected from the group consisting of H, O, F, OH, S, and Cl.

In some approaches, the M in MAX and in the corresponding MXene is selected from the group consisting of: Sc, Ti, V, Cr, Y Zr, Nb, Mo, Hf, Ta, W, and Mn. In further approaches, the M in MAX and the corresponding MXene is selected from the group consisting of: Ce, Pr, Nd, Sm, Gd, Tb, Dy, Ho, Er, Tm, Yb and Ly.

The A group element in the MAX, according to various approaches, may be selected from the group consisting of: Fe, Ir, Cy, Au, Zn, Cd, Al, Ga, In, Ti, Si, Ge, Sn, Pb, P, As, Sb, Bi and S.

The intercalated ions in various approaches may be selected from the group consisting of: H, Li, Na, K, Rb, Cs, Mg, Ca, Sr, Ba, Cr, Re, Fe, Co, Ni, Pd, Pt, Cy, Ag, Zn, Cd, Hg, Al, Sn, and Pb.

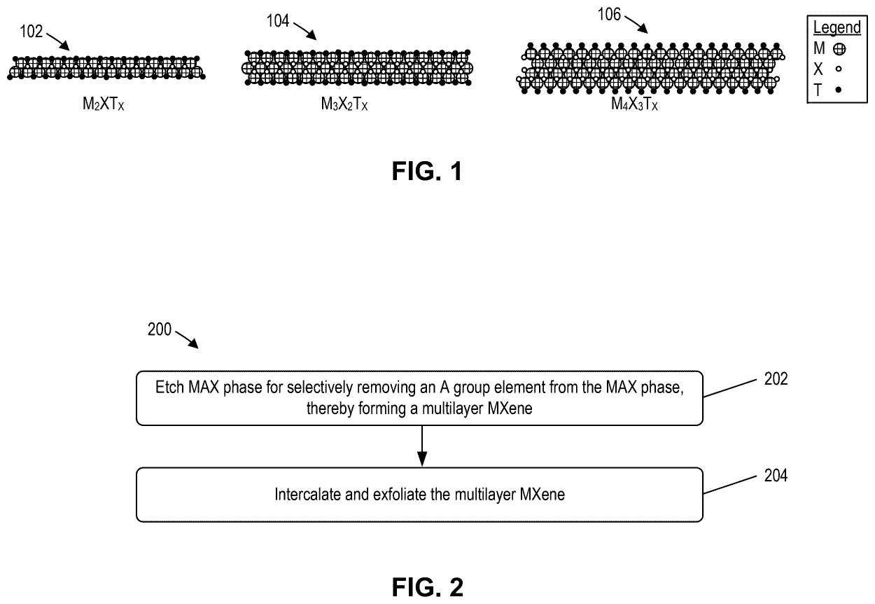

FIG. 1 depicts three exemplary structures of MXenes that may be produced using the methodology presented herein. As shown, the structures include M₂XTₓ 102, M₃X₂Tₓ 104, and M₄X₃Tₓ 106. M and X in the formulae are as noted above. The Tₓ in the formulae represents surface terminations, such as H, O, F, OH, S and/or Cl, which are bonded to the outer M layers. Fabrication of other MXene structures may also be possible, as would become apparent to one skilled in the art after reading the present disclosure.

The fabricated MXenes may have known structures and/or chemical

compositions. The MXenes fabricated according to various aspects of the methodology presented herein may include mono-transitional metal (mono-M) MXenes, double transition metal (double-M) solid solutions, ordered double-M MXenes, and ordered divacancy MXenes.

Examples of M₂X mono-M MXenes that may be prepared according to the methodology herein include: Sc₂C, Ti₂C, Ti₂N, Zr₂C, Zr₂N, Hf₂C, Hf₂N, V₂C, V₂N, Nb₂C, Ta₂Cm Cr₂C, Cr₂N, Mo₂C, W₂C, Mo₂N, Nb_{1.3}C, and Mo_{1.3} Y_{0.6}C.

Examples of M₂X double-M solid solution MXenes that may be prepared according to the methodology herein include: (Ti,V)₂C and (Ti,Nb)₂C.

An example of a M₂X ordered double-M MXene that may be prepared according to the methodology herein includes: Mo_{1.3} Y_{0.6}C.

Examples of M₂X ordered divacancy MXenes that may be prepared according to the methodology herein include: Mo_{1.3C}, C, Cr_{1.3}C, and W_{1.3}C.

Examples of M₃X₂ mono-M MXenes that may be prepared according to the methodology herein include: Ti₃C₂, Ti₃N₂, Ti₃(CN), Zr₃C₂, and Hf₃C₂.

An example of a M₃X₂ double-M solid solution MXene that may be prepared according to the methodology herein includes (Ti,V)₃C₂.

Examples of M₃X₂ ordered double-M MXenes that may be prepared according to the methodology herein include: (Ti₂Nb)C₂, (Ti₂Ta)C₂, (Ti₂Mn)C₂, (Hf₂V)C₂, (Hf₂Mn)C₂, (V₂Ti)C₂, (Cr₂Ti)C₂, (Cr₂V)C₂, (Cr₂Nb)C₂, (Cr₂Ta)C₂, (Mo₂Sc)C₂, (Mo₂Ti)C₂, (Mo₂Zr)C₂, (Mo₂Hf)C₂, (Mo₂V)C₂, (Mo₂Nb)C₂, (Mo₂Ta)C₂, (W₂Ti)C₂, (W₂Zr)C₂, and (W₂Hf)C₂.

Examples of M₄X₃ mono-M MXenes that may be prepared according to the methodology herein include: Ti₄N₃, V₄C₃, Nb₄C₃, and Ta₄C₃.

Examples of M₄X₃ double-M solid solution MXenes that may be prepared according to the methodology herein include: (Ti,Nb)₄C₃, and (Nb,Zr)₄C₃.

Examples of M₄X₃ ordered double-M MXenes that may be prepared according to the methodology herein include: (Ti₂Nb₂)C₃, (Ti₂Ta₂)C₃, (V₂Ti₂)C₃, (V₂Nb₂)C₃, (V₂Ta₂)C₃, (Nb₂Ta₂)C₃, (Cr₂Ti₂)C₃, (Cr₂V₂)C₃, (Cr₂Nb₂)C₃, (Cr₂Ta₂)C₃, (Mo₂Ti₂)C₃, (Mo₂Zr₂)C₃, (Mo₂Hf₂)C₃, (Mo₂V₂)C₃, (Mo₂Nb₂)C₃, (Mo₂Ta₂)C₃, (W₂Ti₂)C₃, (W₂Zr₂)C₃, and (W₂Hf₂)C₃.

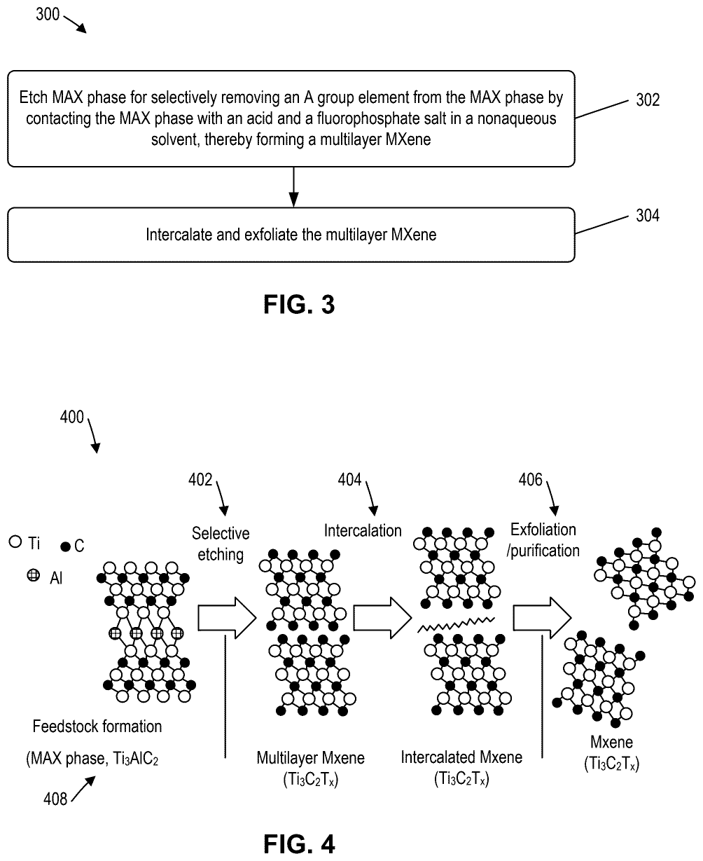

FIG. 2 shows a method 200 for fabricating a MXene in accordance with one approach. As an option, the present method 200 may be implemented to fabricate MXenes such as those described elsewhere herein, using any of the steps described herein with reference to FIGS. 2-3 and/or to other FIGS. Of course, however, this method 200 and others presented herein may be used to form MXenes in a wide variety of chemical compositions and structures, using materials which may or may not be specifically listed in the illustrative approaches described herein. Further, the methods presented herein may be carried out in any desired environment. Moreover, more or less operations than those shown in FIGS. 2-3 may be included in method 200, according to various approaches. It should also be noted that any of the aforementioned features may be used in any of the approaches described in accordance with the various methods.

In step 202 of FIG. 2, a MAX phase is etched for selectively removing an A group element from the MAX phase, thereby forming a multilayer MXene. The etching step may include contacting a salt and an etchant with the MAX phase in a nonaqueous solvent.

The MAX phase may be any MAX phase disclosed herein, or that would become apparent to one skilled in the art after reading the present disclosure.

The salt may include one or more salts. The etchant may include one or more acids. While exemplary salts and etchants are presented herein, any known salt and/or etchant that would become apparent to one skilled in the art after reading the present disclosure, and that can be verified via routine experimentation as being effective for the appropriate function as described herein, may be used in various approaches.

Preferably, the salt and etchant are mixed with a nonaqueous solvent having a high dielectric constant (which is defined herein to be a dielectric constant >15) to create a mixture, to which the MAX is added and mixed into the mixture.

In a preferred approach for performing the method 200, as depicted in the variant 300 shown in FIG. 3, step 302 includes contacting the MAX phase with an acid and a fluorophosphate salt in a nonaqueous solvent for selectively removing the A group element from the MAX phase, thereby forming the multilayer MXene. Step 304 is similar to step 204 of FIG. 2.

With continued reference to FIGS. 2-3, illustrative fluorophosphate salts include NH₄PF₆, KPF₆, NaPF₆, LiPF₆, and Na₂FPO₃.

In some approaches, the acid is a sulfonic acid. Illustrative sulfonic acids include HOCH₂CH₂CH₂SO₃H (3-Hydroxypropane-1-sulfonic acid); an alkanesulfonic acid such as methaneulsolfonic acid (CH₃SO₃H), ethanesulfonic acid, propanesulfonic acid, etc.; and C₇H₈O₃S.

In some approaches, the acid is a phosphonic acid. Illustrative phosphonic acids include any version of Hₙ₊₂PₙO₃ₙ₊₁, where n=1-5.

In some approaches, the MAX phase is contacted with one or more sulfonic acids and one or more phosphonic acids as the main etchants, simultaneously.

In some approaches, the MAX phase is contacted with one or more sulfonic acids, one or more phosphonic acids, and one or more and the fluorophosphate salts simultaneously. This has been found to provide a synergistic effect that results in very high yields, e.g., of up to about 75% or more by weight relative to a starting weight of the MAX phase.

Illustrative nonaqueous solvents with high dielectric constant include dimethylsulfoxide (DMSO), dimethylformamide (DMF), propylene carbonate (PC), and fluorine containing ionic liquids (e.g. EMIMBF₄). While exemplary nonaqueous solvents are presented herein, any known nonaqueous solvent that would become apparent to one skilled in the art after reading the present disclosure, and that can be verified via routine experimentation as being effective for the appropriate function as described herein, may be used in various approaches.

Regarding concentrations of the various components used in the etching step, the following amounts of each component may be used per 1 liter of anhydrous solvent. The salt may be present from a minimum effective amount to assist in the etching up to a solubility limit of the salt. Preferably, the salt is present at about 50-400 g of salt per liter of anhydrous solvent, more preferably about 200-350 g of salt. The acid is preferably present at about 25-250 ml of acid per liter of anhydrous solvent, more preferably about 50-150 ml of acid. The MAX phase is preferably present at about 25-125 g per liter of anhydrous solvent. Of course, these ranges are preferred and presented by way of example only as optimal quantities, and various approaches may use one or more components at a weight or volume outside of the listed ranges. Note that where two or more salts are used, the combined weight of the salts may be in the foregoing range (e.g., effective amount up to solubility limit of each salt). Likewise in approaches using two or more acids, the total volume of the acids may be in the foregoing range.

The initial mixing of the components with the solvent preferably includes combining the salt and the acid with the solvent, agitating (e.g., mixing) the thus-combined components for an effective amount of time to homogenize the components, and then the MAX phase is added thereto. Further agitation may be performed to disperse the MAX phase in the mixture. This sequence may be performed at any suitable temperature, e.g., in a range from below room temperature up to a boiling point of the solvent. Preferably, the initial mixing of the components with the solvent is performed at around room temperature. The mixture may be enclosed in an air-tight container and the reaction allowed to proceed up to an amount of time to reach the maximum extent of reaction.

In a preferred approach, after all components are combined together, the resulting mixture may optionally be heated to any suitable temperature above room temperature, e.g., up to a boiling point of the solvent. The warmer the mixture is heated to, the faster the reaction proceeds. Moreover, the inventors surprisingly found that the yield of MXene increases at higher temperatures, relative to room temperature. Accordingly, in a particularly preferred approach, the mixture is heated to a temperature in a range of about 90-110° C. and held at that temperature for an effective amount of time to reach a predetermined extent of reaction, e.g., a predefined or expected production yield, to reach or nearly reach a maximum extent of reaction, etc. In some cases, the amount of time may be in a range of about 2 hours to about 5 days.

The inventors also surprisingly discovered that increasing the temperature above 110° C. did not improve yield compared to experiments conducted at temperatures around 100° C. Thus, while approaches such as refluxing near the boiling point of the solvent may be used to speed up the reaction, the yield will likely not improve.

In step 204, intercalation and exfoliation of the multilayer MXene occurs. Known techniques for intercalation and/or exfoliation of multilayer MXenes may be used in step 204.

The intercalation may include agitating the multilayer MXene in a nonaqueous solvent for forming pellets of the multilayer MXene. In an exemplary approach, the intercalation includes separating the multilayer MXenes from the etchant liquid and byproducts, e.g., via centrifugation and removal of at least a majority of the etchant liquid and byproducts, e.g., by pouring off of the liquid, removal via suction, etc. A nonaqueous solvent may be added to the multilayer MXene-containing remnant remaining after separation, the resulting mixture agitated, centrifuged, and the liquid again substantially removed. This process may be repeated multiple times, e.g., 3-10 times to wash the resulting pellets of multilayer MXene. The nonaqueous solvent may be the same as or different than a nonaqueous solvent used in the etching step.

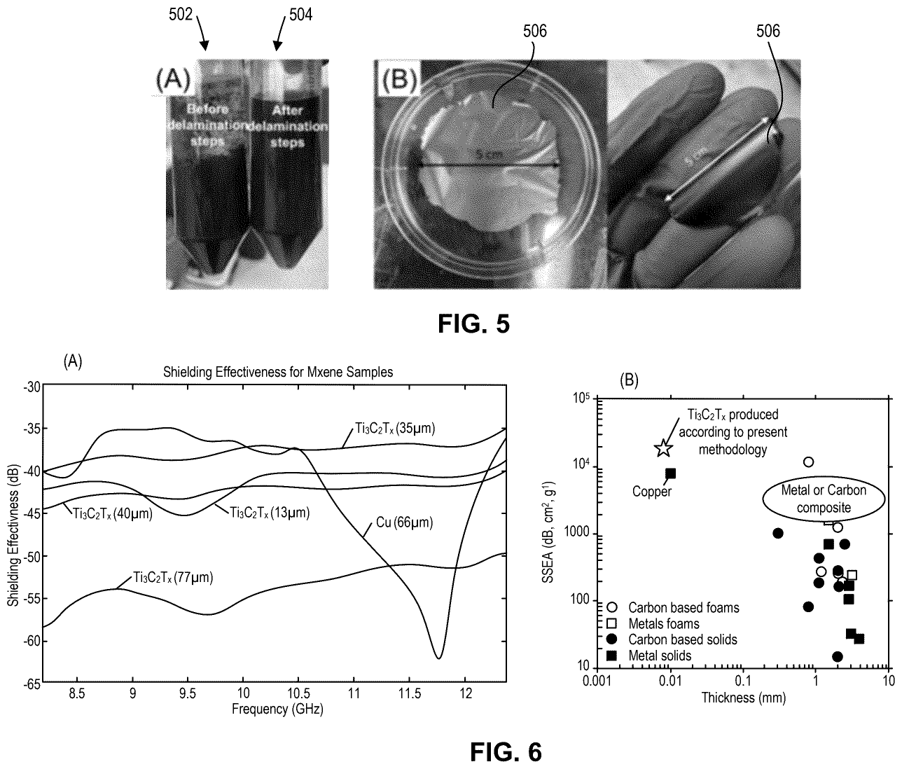

The exfoliation results in delamination of the multilayer MXenes. The exfoliating may include agitating a mixture of: the pellets of multilayer MXene, a nonaqueous solvent, and water. Preferably, the same nonaqueous solvent used in the etching step is used in the exfoliation and delamination, because the inventors have found that use of the same nonaqueous solvent results in better efficiency in the delamination step, believed to be due to better surface compatibility. The water may be present in a range of 0-100 vol % relative to the combined weight of the water (if present) and nonaqueous solvent (if present), and is preferably present in a range of about 5-20 vol % relative to the total weight of the water and nonaqueous solvent. The agitating may be performed at about room temperature (or other temperature) for a predetermined amount of time, e.g., 2-100 minutes. The agitated mixture may then be separated, e.g., via centrifugation, to recover the delaminated MXene suspended in the supernatant. The supernatant may be poured over a membrane such as filter paper, etc., preferably with vacuum assistance, to recover a sheet of MXene from the supernatant. See, e.g., FIG. 5, part (B). The remaining portion of the MXene pellets may again be mixed with nonaqueous solvent and water, agitated, centrifuged, and the supernatant processed to recover delaminated MXene. This process may be repeated several times.

The method 200 is capable of producing exfoliated MXene at a production yield of greater than 25% by weight relative to a starting weight of the MAX phase, and in any cases greater than a 50% yield by weight. In some cases, the production yield of the exfoliated MXene is greater than 70% by weight relative to a starting weight of the MAX phase. Yields up to about 75% have been achieved experimentally with optimized concentrations of Na₂FPO₃ and C₇H₈O₃S in DMSO, as well as optimized concentrations of Na₂FPO₃ and C₇H₈O₃S in PC, at 100° C. for 24 h., indicating that yields could be even higher than 75% for some MXenes. The yield for any particular MXene would be readily determinable via basic experimentation following the methodology set forth herein.

FIG. 4 is a graphical representation of a method 400 for performing a scalable solution-phase synthesis of freestanding MXene via top-down exfoliation, in accordance with various approaches. As an option, the present method 400 may be implemented to fabricate MXenes such as those described elsewhere herein, using any of the steps described herein with reference to FIGS. 2-3 and/or to other FIGS. Of course, however, this method 400 and others presented herein may be used to form MXenes in a wide variety of chemical compositions and structures, using materials which may or may not be specifically listed in the illustrative approaches described herein. Further, the methods presented herein may be carried out in any desired environment. Moreover, more or less operations than those shown in FIG. 4 may be included in method 400, according to various approaches. It should also be noted that any of the aforementioned features may be used in any of the approaches described in accordance with the various methods.

Referring to FIG. 4, the MXene in this example is Ti₃C₂Tₓ, though the method would be readily adaptable to fabrication of other MXenes, as would become apparent to one skilled in the art after being apprised of the present disclosure.

The method 400 includes three steps: selective etching 402, intercalation 404, and exfoliation/purification 406. In one experiment, the MAX phase 408 was Ti₃AlC₂. However, other MAX phase precursors may be used to produce other types of MXenes, as alluded to in the previous paragraph.

In step 402, selective etching is performed to eliminate the A component in the MAX phase 408 with non-aqueous solvent and salt. In the aforementioned experiment, the A component was Al. In the experiment, 6 g of NH₄HF₂ and 3 g of KPF₆ were dissolved in 50 ml anhydrous DMSO in a PTFE container. Then, 3 g of 3-Hydroxy-1-propanesulfonic acid sodium salt was added to the solution. The solution was stirred for 60 min. Then, 1 g of Ti₃AlC₂ was slowly added in the solution. The mixture was air-sealed and placed in an oil bath, which was heated to 100° C., held for 2 h, and then cooled naturally back to room temperature. The detailed reaction procedure is as follows:

Ti₃AlC₂(MAX precursor)+3(NH₄HF₂)(salt, etchants)=>(NH₄)₃AlF₆(byproducts)+Ti₃C₂(MXene)+3/2H₂

The solvents used in step 402 may be DMSO, DMF, PC, and/or fluorine containing ionic liquids (e.g., EMIMBF₄). The salts and etchants may be NH₄HF₂, CoFₓ, NH₄F, alkanesulfonic acid such as CH₃SO₃H, and/or NH₄PF₆.

Next, intercalation and exfoliation/purification are performed in steps 404 and 406 to produce the MXene. In the experiment, intercalation and exfoliation/purification were performed to generate Ti₃C₂Tx MXene from multilayer Ti₃C₂Tx MXenes and byproducts mixtures (e.g., (NH₄)₃AlF₆).

In step 404, during the experiment, the resulting multilayer MXenes were separated via centrifugation at 8000 rpm for 30 min, and then 180 ml of anhydrous DMSO was added to the resulting pellets and shaken by hand for 2 minutes for fully dispersion. This procedure was repeated 5 times.

In step 406, for the purification and the delamination of multilayer Ti₃C₂Tx MXene in the experiment, 150 ml of 90 vol % of DMSO with 10 vol % of DI water mixture was added to the resulting pellets and agitated via manual shaking for 2 minutes, followed by centrifugation for 10 min at 3000 rpm. After the centrifugation, the supernatants were collected. This procedure was repeated three times. The weight of the collected Ti₃C₂Tx was above 0.7 g, which is over 70% production yield, relative to the starting amount of 1 g of precursor.

In another experiment, which achieved an approximately 75% yield, 6 g of NH₄HF₂ and ₄ g of Na₂FPO₃ were dissolved in 50 ml anhydrous DMSO in a PTFE container. Then, 8 g of C₇H₈O₃S was added in the solution and stirred from 30 min. Subsequently, 1 g of Ti₃AlC₂ was slowly added to the solution. The mixture was air-tightened and placed in an oil bath, which was heated to 100° C., held for 24 h, and then allowed to cooled naturally. The detail reaction procedure was:

Ti₃AlC₂(MAX precursor)+3(NH₄HF₂) (salt, etchants)=>(NH₄)₃AlF₆(byproducts)+Ti₃C₂(MXene)+3/2H₂

Similar intercalation and exfoliation/purification steps as those in the former experiment were performed.

Following the exfoliation/purification procedure, to prepare freestanding films, the supernatant may be filtered via vacuum filtration with filter paper, or any other suitable technique known in the art. The resulting film thickness is dependent on the concentration and volume of supernatant. During experimentation, films with approximately 40 μm thickness were created using 80 ml of Ti₃C₂Tₓ with 2 mg/ml solution.

FIG. 5, part (A), shows the colloidal stability of resulting Ti₃C₂Tₓ MXene in DMSO before (502) and after (504) the delamination and purification steps. The sample 502 before the delamination and purification steps in this example includes pellets of multilayer MXenes and by-products. In the sample 504 of material after the delamination and purification steps, the MXenes are suspended in the solution.

Part (B) of FIG. 5 shows the resulting freestanding sheet 506 of MXene produced by vacuum filtration through a membrane upon which the MXene is deposited. The image on the right hand side illustrates the flexibility of the sheet 506 of MXene.

SE performance of the freestanding films prepared by resulting Ti₃C₂Tₓ MXene are shown in FIG. 6. Particularly, part (A) of FIG. 6 shows the shielding effectiveness of freestanding films of Ti₃C₂Tₓ MXene of the noted film deposition thickness, prepared as noted herein. Cu foil of 66 micrometers thick is presented as a comparison. The chart is based on actual measurements taken during experimentation. FIG. 6, part (B), illustrates normalized shielding effectiveness by density and weight (SSE/t) of the resulting Ti₃C₂Tₓ MXene vs. other materials. As shown, the shielding performance relative to weight is far above any of the comparable materials.

The SE of the resulting MXene is dependent upon the film thickness. Referring to FIG. 6, part (A), the SE with 77 μm thickness films outperforms conventional Cu foils in most frequencies in the range of 8-12 GHz. Furthermore, the normalized SE by density and thickness (SSE/t) of the resulting Ti₃C₂Tₓ MXene is an order of magnitude higher than that of conventional Cu, as shown in part (B) of FIG. 6. Moreover, the SSE/t results in dramatic weight saving (e.g., 53 g for MXENE vs 1 kg for commercial metal products) for comparable SE (80 dB) at a m²-area.

The approaches presented herein may be used to replace the current high-concentrated HF etching process, which suffers from drawbacks such as use of materials that are highly corrosive and highly toxic, operational risks, and adverse environmental effects. In contrast, the present methodology may be performed with less toxic materials, and more environmentally friendly approaches. Furthermore, various approaches presented herein greatly improve the production yield and purity of MXenes compared to conventional etching procedures. Without wishing to be bound by any theory, it is presently believed that the high production yield and purity of MXenes produced according to some approaches is due to the low vapor pressure and high solvating nature of the solvents in the presence of the bifluoride salts, which results in more efficient reactions with the A element layer via in-situ HF generation. Moreover, the present methodology may enable exploration of MXene surface chemistry, orientation, and composition, which are critical parameters that impact MXene's EM performance but are less explored due to synthesis limitation when using conventional synthesis approaches.

### In Use

The MXenes produced according to the methodology presented herein may be used as next-generation EM shielding materials that are lightweight, ultrathin, flexible and highly efficient to protect a system from receiving or emitting undesirable EM radiation such as EMI and EMP, which can cause the leakage of confidential information and targets, lead to the malfunction of electronic devices, and even impair human health.

The MXenes described herein may be used in any application where EM shielding is useful. For example, various types of the MXene-based shielding presented herein may be used, with or without a support structure, to control EM pollution resulting from 5G electronic communication systems and/or any other electronic communication systems known in the art including EMI from mobile phones, laptops, automated vehicles, aviation electronics, radar, military toolkits, etc., and/or or any application using electronic communication systems known in the art. The shield may be adapted to control EMI pollution resulting from electronic communication systems developed in the future as would be understood by one having ordinary skill in the art upon reading the present disclosure.

Furthermore, MXenes created according to the methodology herein may be used to offer diverse functions in energy storage applications such as components for batteries and supercapacitors, catalysis components such as electrocatalysts, electrodeposition substrates, energy harvesting, etc.

In further approaches, MXenes may be utilized to enhance the stability and performance of electrodes, electrolytes and separators due to their hydrophilic surfaces and high metallic conductivities. In doing so, MXenes show promising performance in various applications such as water desalination, catalysis, electronics, transparent and conducting films, sensors and biomedicine.

The inventive concepts disclosed herein have been presented by way of example to illustrate the myriad features thereof in a plurality of illustrative scenarios, approaches, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various approaches have been described above, it should be understood that they have been presented by way of example only, and not limitation. Thus, the breadth and scope of a configuration of the present invention should not be limited by any of the above-described exemplary approaches, but should be defined only in accordance with the following claims and their equivalents.

What is claimed is:

1. A method for fabricating a MXene, the method comprising:
etching a MAX phase for selectively removing an A group element from the MAX phase, thereby forming a multilayer MXene; and
causing intercalation and exfoliation of the multilayer MXene.

2. The method of claim 1, wherein the etching includes contacting a salt and an etchant with the MAX phase in a nonaqueous solvent having a dielectric constant greater than 15.

3. The method of claim 1, wherein the etching includes contacting the MAX phase with an acid and a fluorophosphate salt.

4. The method of claim 3, wherein the fluorophosphate salt is selected from the group consisting of: NH₄PF₆, KPF₆, NaPF₆, LiPF₆, and Na₂FPO₃.

5. The method of claim 3, wherein the acid is selected from the group consisting of:
a sulfonic acid and a phosphonic acid.

6. The method of claim 1, wherein the etching includes contacting the MAX phase with a sulfonic acid, a phosphonic acid, and a fluorophosphate salt.

7. The method of claim 1, wherein a production yield of the exfoliated MXene is greater than 50% by weight relative to a starting weight of the MAX phase.

8. The method of claim 1, wherein a production yield of the exfoliated MXene is at least about 75% by weight relative to a starting weight of the MAX phase.

9. The method of claim 1, wherein the intercalation includes agitating the multilayer MXene in a nonaqueous solvent for forming pellets of the multilayer MXene.

10. The method of claim 1, wherein the exfoliating includes agitating a mixture of the intercalated multilayer MXene, a nonaqueous solvent, and water.

11. A method for fabricating a MXene, the method comprising:
contacting a MAX phase with an acid and a fluorophosphate salt in a nonaqueous solvent for selectively removing an A group element from the MAX phase, thereby forming a multilayer MXene; and
causing intercalation and exfoliation of the multilayer MXene.

12. The method of claim 11, wherein fluorophosphate salt is selected from the group consisting of: NH₄PF₆, KPF₆, NaPF₆, LiPF₆, and Na₂FPO₃.

13. The method of claim 11, wherein the acid is selected from the group consisting of: a sulfonic acid, and a phosphonic acid.

14. The method of claim 13, wherein the acid is the sulfonic acid, wherein the sulfonic acid is selected from the group consisting of: HOCH₂CH₂CH₂SO₃H, an alkanesulfonic acid, and C₇H₈O₃S.

15. The method of claim 13, wherein the acid is the phosphonic acid, wherein the phosphonic acid is Hₙ₊₂PₙO₃ₙ₊₁, where n=1-5.

16. The method of claim 11, wherein the etching includes contacting the MAX phase with a sulfonic acid, a phosphonic acid, and the fluorophosphate salt.

17. The method of claim 11, wherein a production yield of the exfoliated MXene is greater than 50% by weight relative to a starting weight of the MAX phase.

18. The method of claim 11, wherein a production yield of the exfoliated MXene is at least about 75% by weight relative to a starting weight of the MAX phase.

19. The method of claim 11, wherein the intercalation includes agitating the multilayer MXene in a nonaqueous solvent for forming pellets of the multilayer MXene.

20. The method of claim 11, wherein the exfoliating includes agitating a mixture of the intercalated multilayer MXenc. a nonaqueous solvent, and water.
